(19) United States
(12) Patent Application Publication
(10) Pub. No.: US 2025/0115519 A1
(43) Pub. Date: Apr. 10, 2025

(54) CORE-SHELL NANOPARTICLE FOR EARLY STRENGTH DEVELOPMENT OF CONCRETE, CONCRETE FORMING COMPOSITION INCLUDING THE SAME, AND METHOD FOR PRODUCING THE SAME

(71) Applicant: SILKROAD C&T CO., LTD., Seoul (KR)

(72) Inventors: Jung Sun KIM, Seoul (KR); Su II KIM, Seoul (KR); Bo Chan SEO, Suwon-si (KR); Kwang Hoon SONG, Yongin-si (KR)

(73) Assignee: SILKROAD C&T CO., LTD., Seoul (KR)

(21) Appl. No.: 18/681,955

(22) PCT Filed: Sep. 15, 2022
(86) PCT No.: PCT/KR2022/013788

§ 371 Date: Feb. 7, 2024

(30) Foreign Application Priority Data
Sep. 15, 2021 (KR) 10-2021-0123392

(51) Int. Cl. C04B 22/06; C04B 14/06; C04B 20/10; C04B 28/04

(52) U.S. Cl. CPC C04B 22/064; C04B 14/062; C04B 20/1033; C04B 20/1066; C04B 28/04; C04B 2201/50

(57) ABSTRACT

A core-shell nanoparticle and a method for producing the core-shell nanoparticle are disclosed. The core-shell nanoparticle is suitable for early strength development of concrete, which can adjust the size of the core-shell nanoparticle according to the particle size of colloidal metal oxide and can be used as an early strength agent to accelerate early strength development of concrete.

### TECHNICAL FIELD

The present invention relates to a core-shell nanoparticle and a method for producing the same, and more particularly, to a core-shell nanoparticle for early strength development of concrete, which can adjust the size of the core-shell nanoparticle according to the particle size of colloidal metal oxide and can be used as an early strength agent to accelerate early strength development of concrete.

### BACKGROUND ART

An admixture is a material that is added in addition to cement, aggregate, and water, which are the basic materials for concrete production, to give special performance to concrete or to improve properties, and refers to a material whose amount used is less than 1% (based on solid content) with respect to cement. However, despite the relatively small amount used, the development of excellent admixtures is recognized as one of the most important factors in the development of concrete materials because the physical properties of concrete change significantly depending on the admixture used. The current mainstream of concrete admixture is AE water reducing agents, high performance water reducing agents, and high performance AE water reducing agents, and synthetic surfactants, lignin sulfonic acids, naphthalene-based admixtures, melamine-based admixtures, and polycarboxylic acid-based admixtures are used as main ingredients, but they do not guarantee the early strength or ultra-short-term strength performance of concrete.

On the other hand, it is required to use inexpensive industrial by-products, such as fly ash and blast furnace slag, which can reduce the proportion of cement and replace cement when cement concrete is produced. The amount of industrial by-products generated is increasing year by year and more than 20 million tons of industrial by-products are generated annually. Accordingly, industrial by-products are desirable as a substitute for cement. However, when industrial by-products are applied, there is a problem that the early strength of concrete is reduced. Therefore, the need for early strength additives is gradually emerging to solve this problem.

In addition, when concrete is placed in winter, the strength development of concrete is significantly delayed and the construction period is lengthened. To solve this problem, heat is applied around the placed concrete to shorten the strength development time. However, since this leads to an increase in the construction cost, it is a major issue to shorten the strength development time of concrete.

In addition, in precast concrete that is produced by pouring concrete into a mold, the early strength development of concrete is an important part. In particular, in the precast, the strength of concrete is rapidly developed by steam curing using steam. At this time, a large amount of energy is consumed. Since the precast is to produce molded concrete having a certain shape, the rotation rate of the mold used is one of the important parts. Therefore, the early strength development of concrete is an important factor in order to use less energy and increase the rotation rate of the mold.

Various materials are applied to increase the early strength of conventional cement concrete. However, since each of the materials required when producing cement concrete by applying these materials is mixed, there is a disadvantage in that it is inconvenient to use. In addition, when these materials are simply mixed, a problem such as precipitation and reaction may occur.

In this regard, Korean Patent Registration No. 10-1963579 discloses an early strength-developed concrete composition which is applicable to a part requiring early strength development.

### DESCRIPTION OF EMBODIMENTS

### Technical Problem

The present invention has been made in an effort to solve the problems of the related art, and an object of the present invention is to provide a core-shell nanoparticle capable of accelerating early strength development of hydraulic materials, particularly concrete, and a concrete forming composition including the same.

In addition, an object of the present invention is to provide a method for producing a core-shell nanoparticle, which is capable of adjusting the size of the core-shell nanoparticle according to the particle size of colloidal metal oxide.

### Solution to Problem

To achieve the objects described above, an aspect of the present invention is to provide a core-shell nanoparticle including: a core including a metal oxide; and a shell positioned on the surface of the core and including an inorganic compound including calcium, wherein the metal oxide includes at least one metal selected from the group consisting of metalloids, transition metals, post-transition metals, and lanthanum metals.

The metal oxide may include at least one selected from the group consisting of silica (SiO₂), titanium dioxide (TiO₂), cerium oxide (CeO₂), zinc oxide (ZnO), aluminum oxide (Al₂O₃), zirconium oxide (ZrO₂), manganese oxide (MnO₂), iron oxide (Fe₂O₃), vanadium oxide (V₂O₅), tin oxide (SnO₂), and tungsten oxide (WO₃).

The inorganic compound including calcium may include at least one selected from the group consisting of calcium silicate, calcium titanate, calcium cerate, calcium zincate, calcium aluminate, calcium zirconate, calcium permanganate, calcium ferrite, calcium vanadate, calcium stannate, calcium tungstate, and any hydrate thereof.

The shell may further include a polycarboxylate ether-based compound.

Another aspect of the present invention is to provide a concrete forming composition including aggregate, a binder, an admixture, and water, wherein the admixture includes the core-shell nanoparticle for early strength development of concrete.

Another aspect of the present invention is to provide a method for producing a core-shell nanoparticle for early strength development, the method including producing a core-shell nanoparticle by stirring a first solution containing a water-soluble calcium compound and a second solution containing a water-dispersible colloidal metal oxide.

A ratio (d:r) of a particle size (d) of the colloidal metal oxide to a particle size (r) of the core-shell nanoparticle may be 1:1.005 to 1:30.

The water-soluble calcium compound may include at least one selected from the group consisting of calcium nitrate, calcium chloride, calcium formate, calcium acetate, calcium bicarbonate, calcium bromide, calcium carbonate, calcium citrate, calcium chlolate, calcium fluoride, calcium gluconate, calcium hydroxide, calcium oxide, calcium hypochlorite, calcium iodide, calcium lactate, calcium nitrite, calcium oxalate, calcium phosphate, calcium propionate, calcium silicate, calcium stearate, calcium sulfate, calcium sulfate hemihydrate, calcium sulfate dihydrate, calcium sulfide, calcium tartrate, calcium aluminate, tricalcium silicate, dicalcium silicate, and any hydrate thereof.

The first solution and the second solution may each independently further include at least one selected from the group consisting of a dispersant, an alkali metal hydroxide, and any combination thereof.

The dispersant may include a polycarboxylate ether-based compound.

The alkali metal hydroxide may include at least one selected from the group consisting of sodium hydroxide (NaOH), potassium hydroxide (KOH), and lithium hydroxide (LiOH).

The first solution may further include a dispersant, and the first solution may include 50-150 parts by weight of the dispersant based on 100 parts by weight of the water-soluble calcium compound.

The second solution may further include an alkali metal hydroxide, and the second solution may include 100-200 parts by weight of the alkali metal hydroxide based on 100 parts by weight of the water-dispersible colloidal metal oxide.

The method may further include, after the step of producing the core-shell nanoparticle, drying the core-shell nanoparticle.

### Advantageous Effects of Disclosure

A core-shell nanoparticle according to the present invention can accelerate early strength development of hydraulic materials, especially concrete, and thus can be used as an early strength development accelerator, and has an effect of shortening the construction period and reducing the construction cost.

In addition, a method for producing a core-shell nanoparticle according to the present invention has an effect of adjusting the size of the core-shell nanoparticle according to the particle size of colloidal metal oxide.

### BRIEF DESCRIPTION OF DRAWING

FIG. 1 is a flowchart of a method for producing a core-shell nanoparticle for early strength development of concrete according to the present invention.

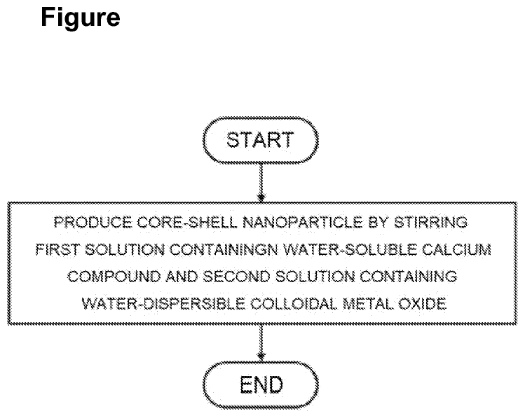

### MODE OF DISCLOSURE

Hereinafter, the present invention will be described in more detail. However, the present invention may be embodied in various different forms and is not limited by embodiments described herein, and the present invention is only defined by the claims to be described below.

In addition, the terms as used herein are only used to describe specific embodiments, and are not intended to limit the present invention. The singular forms “a,” “an,” and “the” as used herein are intended to include the plural forms as well unless the context clearly indicates otherwise. In the specification of the present invention, the phrase “including a certain element” means “further including other elements” rather than excluding other elements unless otherwise stated.

A first aspect of the present application provides a core-shell nanoparticle for early strength development of concrete, which includes a core including a metal oxide, and a shell positioned on the surface of the core and including an inorganic compound including calcium.

Hereinafter, the core-shell nanoparticle for early strength development of concrete according to the first aspect of the present application will be described in detail.

According to an embodiment of the present application, the core-shell nanoparticle may include a core including a metal oxide.

According to an embodiment of the present application, the metal oxide may include at least one metal selected from the group consisting of metalloids, transition metals, post-transition metals, and lanthanum metals.

According to an embodiment of the present application, the metal oxide may include at least one selected from the group consisting of silica (SiO₂), titanium dioxide (TiO₂), cerium oxide (CeO₂), zinc oxide (ZnO), aluminum oxide (Al₂O₃), zirconium oxide (ZrO₂), manganese oxide (MnO₂), iron oxide (Fe₂O₃), vanadium oxide (V₂O₅), tin oxide (SnO₂), and tungsten oxide (WO₃).

According to an embodiment of the present application, the metal oxide may preferably include silica (SiO₂).

According to an embodiment of the present application, the core-shell nanoparticle for early strength development of concrete may include a shell positioned on the surface of the core and including an inorganic compound including calcium.

According to an embodiment of the present application, the inorganic compound including calcium may include at least one selected from the group consisting of calcium silicate, calcium titanate, calcium cerate, calcium zincate, calcium aluminate, calcium zirconate, calcium permanganate, calcium ferrite, calcium vanadate, calcium stannate, calcium tungstate, and any hydrate thereof.

According to an embodiment of the present application, the inorganic compound including calcium may preferably include at least one selected from the group consisting of calcium silicate and calcium silicate hydrate.

In general, in a cement hydration process, a cement compound reacts with water to form a hydrate and is set while losing fluidity. As more time passes, a hydration process further proceeds. The strength of the structure is increased through a hardening process. Accordingly, hydration and hardening (strength) form a close relationship. The hydrate includes tricalcium silicate (3CaOSiO₂) called alite (C₃S) and dicalcium silicate (2CaOSiO₂) commonly called belite (C₂S). C₃S accounts for the largest proportion of the cement compound. C₂S reacts with water to directly produce calcium hydroxide [Ca(OH)₂] and calcium silicate hydrate (C—S—H, hereinafter abbreviated as “CSH”). At this time, it is known that the initial production rate of CSH, which is the final hydration product of the cement compound, has a great influence on whether the early strength of concrete is secured, and this is known as the rate determining step of the hydration process, which usually takes as little as 6 hours and as much as 10 hours.

Therefore, when the core-shell nanoparticle according to the present invention, which includes the core including silica (SiO₂) and the shell including the CSH, is mixed with the concrete mixture, the core-shell nanoparticle acts as a nucleation seed because the shell material includes the CSH. As the core-shell nanoparticle grows larger, the core-shell nanoparticle fills a void between cement particles, and thus, it is possible to omit the initial cement hydration process, which is the existing rate determining step. Therefore, the curing time of concrete can be drastically reduced. Due to this addition, the construction period of the construction site can be shortened to ⅔ compared to the existing construction period through the realization of early strength development that is impossible in the existing concrete and the development of applied technology. Accordingly, there is an advantage that can increase process efficiency and can dramatically reduce energy.

According to an embodiment of the present application, the core-shell nanoparticle for early strength development of concrete may further include a polycarboxylate ether-based compound.

A second aspect of the present application provides a concrete forming composition including aggregate, a binder, an admixture, and water.

Hereinafter, the concrete forming composition according to the second aspect of the present application will be described in detail.

According to an embodiment of the present application, the concrete forming composition may include aggregate.

The aggregate is the base of the concrete forming composition and is a mineral material for construction that can be agglomerated by the binder to form a single mass.

According to an embodiment of the present application, the aggregate included in the concrete forming composition may include fine aggregate and coarse aggregate. In the present specification, the fine aggregate refers to an aggregate of a particle size that passes 100% through a 5-mm standard mesh. In the present specification, the coarse aggregate refers to an aggregate of a particle size that remains 100% in a 5-mm standard mesh.

According to an embodiment of the present application, the fine aggregate may include crushed sand, natural sand, washed sand, recycled aggregate having a particle size of 0.01-5 mm, or any combination thereof. According to an embodiment of the present application, the fine aggregate may preferably be crushed sand, but is not limited thereto.

According to an embodiment of the present application, the coarse aggregate may include crushed stone, crushed slag, natural gravel, crushed gravel, recycled aggregate having a particle size of 5-25 mm, or any combination thereof. According to an embodiment of the present application, the coarse aggregate may be crushed gravel, but is not limited thereto.

According to an embodiment of the present application, the amount of the aggregate may be 60-90 parts by weight based on 100 parts by weight of the total amount of the concrete forming composition. When the amount of the aggregate is less than 60 parts by weight based on 100 parts by weight of the total amount of the concrete forming composition, in the case of producing concrete from the concrete forming composition, the compressive strength of concrete increases, but the production cost of concrete increases. When the amount of the aggregate is greater than 90 parts by weight based on 100 parts by weight of the total amount of the concrete forming composition, separation between the aggregate and the binder may occur and the quality of concrete may deteriorate.

According to an embodiment of the present application, the fine aggregate ratio (S/A) of the concrete forming composition may be 35-65%. The fine aggregate ratio (S/A) refers to the percentage of the absolute volume of the fine aggregate(S) with respect to the total aggregate (A) (fine aggregate+coarse aggregate). When the fine aggregate ratio (S/A) of the concrete forming composition is less than 35%, the unit quantity and unit cement quantity decrease, resulting in a decrease in workability. In addition, there is a problem in that it becomes rough concrete and may show a phenomenon of separation from other materials. When the fine aggregate ratio (S/A) of the concrete forming composition is greater than 65%, there is a problem in that drying shrinkage, settlement cracks, and plastic shrinkage cracks increase.

According to an embodiment of the present application, the concrete forming composition may include a binder.

The binder serves to impart durability and strength to concrete by improving and maintaining adhesion between the aggregates (for example, the fine aggregate or the coarse aggregate) included in the concrete forming composition.

According to an embodiment of the present application, the binder may include ordinary Portland cement, early strength Portland cement, lime cement, slag cement, blast furnace slag cement, Portland pozzolan cement, fly ash, bottom ash, gypsum cement, silica fume, low heat cement, or any combination thereof.

According to an embodiment of the present application, the binder may include ordinary Portland cement, slag cement, blast furnace slag cement, or any combination thereof, but is not limited thereto.

According to an embodiment of the present application, the amount of the binder may be 1-50 parts by weight based on 100 parts by weight of the total amount of the concrete forming composition. When the amount of the binder is within the above range with respect to 100 parts by weight of the total amount of the concrete forming composition, the production cost of concrete can be reduced and watertightness can be improved.

According to an embodiment of the present application, the water-to-binder ratio (W/B) of the concrete forming composition may be 20-60%. According to an embodiment of the present application, the water-to-binder ratio (W/B) of the concrete forming composition may be 40-50%. The water-to-binder ratio (W/B) refers to the percentage of the amount of water (W) with respect to the binder (B). When the water-to-binder ratio (W/B) of the concrete forming composition is less than 20%, the fluidity of the concrete produced from the concrete forming composition may be reduced. When the water-to-binder ratio (W/B) of the concrete forming composition is greater than 60%, the durability and strength of the concrete produced from the concrete forming composition may be reduced.

According to an embodiment of the present application, the concrete forming composition may include an admixture.

According to an embodiment of the present application, the admixture may include a core-shell nanoparticle for early strength development of concrete.

According to an embodiment of the present application, the core-shell nanoparticle may include a core including a metal oxide, and a shell positioned on the surface of the core and including an inorganic compound including calcium.

According to an embodiment of the present application, the metal oxide may include at least one metal selected from the group consisting of metalloids, transition metals, post-transition metals, and lanthanum metals.

According to an embodiment of the present application, the metal oxide may include at least one selected from the group consisting of silica (SiO₂), titanium dioxide (TiO₂), cerium oxide (CeO₂), zinc oxide (ZnO), aluminum oxide (Al₂O₃), zirconium oxide (ZrO₂), manganese oxide (MnO₂), iron oxide (Fe₂O₃), vanadium oxide (V₂O₅), tin oxide (SnO₂), and tungsten oxide (WO₃).

According to an embodiment of the present application, the inorganic compound including calcium may include at least one selected from the group consisting of calcium silicate, calcium titanate, calcium cerate, calcium zincate, calcium aluminate, calcium zirconate, calcium permanganate, calcium ferrite, calcium vanadate, calcium stannate, calcium tungstate, and any hydrate thereof.

According to an embodiment of the present application, the metal oxide may preferably include silica (SiO₂), and the inorganic compound including calcium may preferably include at least one selected from the group consisting of calcium silicate and calcium silicate hydrate.

According to an embodiment of the present application, the core-shell nanoparticle may be provided as an admixture for accelerating early strength development of concrete.

When the core-shell nanoparticle that includes the core including silica (SiO₂) and the shell including at least one selected from the group consisting of calcium silicate and calcium silicate hydrate is used as the admixture, the core-shell nanoparticle acts as a nucleation seed. As the core-shell nanoparticle grows larger, the core-shell nanoparticle fills a void between cement particles, and thus, it is possible to omit the initial cement hydration process, which is the existing rate determining step. Therefore, the curing time of concrete can be drastically reduced. Due to this addition, the construction period of the construction site can be shortened to ⅔ compared to the existing construction period through the realization of early strength development that is impossible in the existing concrete and the development of applied technology. Accordingly, there is an advantage that can increase process efficiency and can dramatically reduce energy.

According to an embodiment of the present application, the concrete forming composition may include water.

Any water may be used as long as the water does not contain harmful substances, for example, oil, acid, alkali, salt, and organic matter. The type of usable water is not particularly limited, and underground water, tap water, and the like may be used.

A third aspect of the present application provides a method for producing a core-shell nanoparticle for early strength development of concrete, the method including producing a core-shell nanoparticle by stirring a first solution containing a water-soluble calcium compound and a second solution containing a water-dispersible colloidal metal oxide.

Hereinafter, the method for producing a core-shell nanoparticle for early strength development of concrete according to the third aspect of the present application will be described in detail.

According to an embodiment of the present application, the method for producing a core-shell nanoparticle may include producing a core-shell nanoparticle by stirring a first solution containing a water-soluble calcium compound and a second solution containing a water-dispersible colloidal metal oxide.

According to an embodiment of the present application, the water-soluble calcium compound may include at least one selected from the group consisting of calcium nitrate, calcium chloride, calcium formate, calcium acetate, calcium bicarbonate, calcium bromide, calcium carbonate, calcium citrate, calcium chlolate, calcium fluoride, calcium gluconate, calcium hydroxide, calcium oxide, calcium hypochlorite, calcium iodide, calcium lactate, calcium nitrite, calcium oxalate, calcium phosphate, calcium propionate, calcium silicate, calcium stearate, calcium sulfate, calcium sulfate hemihydrate, calcium sulfate dihydrate, calcium sulfide, calcium tartrate, calcium aluminate, tricalcium silicate, dicalcium silicate, and any hydrate thereof.

According to an embodiment of the present application, the water-soluble calcium compound may include calcium nitrate hydrate, and preferably calcium nitrate tetrahydrate (Ca(NO₃)₂ 4H₂O).

According to an embodiment of the present application, the first solution and the second solution may each independently further include at least one selected from the group consisting of a dispersant, an alkali metal hydroxide, and any combination thereof.

According to an embodiment of the present application, the dispersant may include a polymer dispersant.

According to an embodiment of the present application, the polymer dispersant may include a polycarboxylate ether-based compound.

The dispersant may inhibit aggregation between particles of the water-soluble calcium compound, the water-dispersible colloidal metal oxide, the alkali metal hydroxide, and the like used in the method for producing a core-shell nanoparticle according to the present invention, and may space the particles apart from each other by using an electrostatic or physical repulsive force. Accordingly, uniform strength can be developed in the entire area of cement concrete, and sufficient workability can be secured while reducing the amount of water mixed.

According to an embodiment of the present application, the first solution may further include the dispersant, and may include 50-150 parts by weight of the dispersant based on 100 parts by weight of the water-soluble calcium compound.

According to an embodiment of the present application, the core-shell nanoparticle may be produced by using the water-dispersible colloidal metal oxide. The metal oxide particle may form the core, and the surface of the metal oxide particle that is the core may react with calcium atom of the water-soluble calcium compound to produce the core-shell nanoparticle.

According to an embodiment of the present application, the metal oxide may include at least one selected from the group consisting of silica (SiO₂), titanium dioxide (TiO₂), cerium oxide (CeO₂), zinc oxide (ZnO), aluminum oxide (Al₂O₃), zirconium oxide (ZrO₂), manganese oxide (MnO₂), iron oxide (Fe₂O₃), vanadium oxide (V₂O₅), tin oxide (SnO₂), and tungsten oxide (WO₃).

According to an embodiment of the present application, the colloidal metal oxide aqueous solution may be a colloidal silica (SiO₂) aqueous solution. In this case, the core-shell nanoparticle in which silica (SiO₂) is the core and the surface of silica (SiO₂) reacts with calcium atom so that calcium silicate or calcium silicate hydrate is the shell may be produced.

According to an embodiment of the present application, the colloidal metal oxide aqueous solution may be a colloidal titanium dioxide (TiO₂) aqueous solution. In this case, the core-shell nanoparticle in which titanium dioxide (TiO₂) is the core and the surface of titanium dioxide (TiO₂) reacts with calcium atom so that calcium titanate or calcium titanate hydrate is the shell may be produced.

According to an embodiment of the present application, the colloidal metal oxide aqueous solution may be a colloidal cerium oxide (CeO₂) aqueous solution. In this case, the core-shell nanoparticle in which cerium oxide (CeO₂) is the core and the surface of cerium oxide (CeO₂) reacts with calcium atom so that calcium cerate or calcium cerate hydrate is the shell may be produced.

According to an embodiment of the present application, the colloidal metal oxide aqueous solution may be a colloidal zinc oxide (ZnO) aqueous solution. In this case, the core-shell nanoparticle in which zinc oxide (ZnO) is the core and the surface of zinc oxide (ZnO) reacts with calcium atom so that calcium zincate or calcium zincate hydrate is the shell may be produced.

According to an embodiment of the present application, the colloidal metal oxide aqueous solution may be a colloidal aluminum oxide (Al₂O₃) aqueous solution. In this case, the core-shell nanoparticle in which aluminum oxide (Al₂O₃) is the core and the surface of aluminum oxide (Al₂O₃) reacts with calcium atom so that calcium aluminate or calcium aluminate hydrate is the shell may be produced.

According to an embodiment of the present application, the colloidal metal oxide aqueous solution may be a colloidal zirconium oxide (ZrO₂) aqueous solution. In this case, the core-shell nanoparticle in which zirconium oxide (ZrO₂) is the core and the surface of zirconium oxide (ZrO₂) reacts with calcium atom so that calcium zirconate or calcium zirconate hydrate is the shell may be produced.

According to an embodiment of the present application, the colloidal metal oxide aqueous solution may be a colloidal manganese oxide (MnO₂) aqueous solution. In this case, the core-shell nanoparticle in which manganese oxide (MnO₂) is the core and the surface of manganese oxide (MnO₂) reacts with calcium atom so that calcium permanganate or calcium permanganate hydrate is the shell may be produced.

According to an embodiment of the present application, the colloidal metal oxide aqueous solution may be a colloidal iron oxide (Fe₂O₃) aqueous solution. In this case, the core-shell nanoparticle in which iron oxide (Fe₂O₃) is the core and the surface of iron oxide (Fe₂O₃) reacts with calcium atom so that calcium ferrite or calcium ferrite hydrate is the shell may be produced.

According to an embodiment of the present application, the colloidal metal oxide aqueous solution may be a colloidal vanadium oxide (V₂O₅) aqueous solution. In this case, the core-shell nanoparticle in which vanadium oxide (V₂O₅) is the core and the surface of vanadium oxide (V₂O₅) reacts with calcium atom so that calcium vanadate or calcium vanadate hydrate is the shell may be produced.

According to an embodiment of the present application, the colloidal metal oxide aqueous solution may be a colloidal tin oxide (SnO₂) aqueous solution. In this case, the core-shell nanoparticle in which tin oxide (SnO₂) is the core and the surface of tin oxide (SnO₂) reacts with calcium atom so that calcium stannate or calcium stannate hydrate is the shell may be produced.

According to an embodiment of the present application, the colloidal metal oxide aqueous solution may be a colloidal tungsten oxide (WO₃) aqueous solution. In this case, the core-shell nanoparticle in which tungsten oxide (WO₃) is the core and the surface of tungsten oxide (WO₃) reacts with calcium atom so that calcium tungstate or calcium tungstate hydrate is the shell may be produced.

As described above, since the core material of the core-shell nanoparticle varies depending on the type of colloidal metal oxide and the surface of the core reacts with the calcium atom, the shell material may also vary depending on the core material.

According to an embodiment of the present application, the water-dispersible colloidal metal oxide may be a colloidal silica aqueous solution, and the colloidal silica aqueous solution may have a solid content of 0.1-50 wt % and an average particle size of 10-1,000 nm.

According to an embodiment of the present application, the alkali metal hydroxide may include at least one selected from the group consisting of sodium hydroxide (NaOH), potassium hydroxide (KOH), and lithium hydroxide (LiOH).

According to an embodiment of the present application, the alkali metal hydroxide may include sodium hydroxide (NaOH).

According to an embodiment of the present application, the second solution may further include the alkali metal hydroxide, and may include 100-200 parts by weight of the alkali metal hydroxide based on 100 parts by weight of the water-dispersible colloidal metal oxide.

According to an embodiment of the present application, the method may include adding water to a reactor, simultaneously adding the first solution and the second solution to the reactor containing the water, and stirring the first solution and the second solution in the reactor containing the water.

According to an embodiment of the present application, the stirring may be mechanical stirring, but is not limited thereto.

According to an embodiment of the present application, the size of the core-shell nanoparticle may be adjusted according to the size of the colloidal metal oxide particle. The core-shell nanoparticle may have different effects of accelerating early strength according to the size and surface composition thereof.

According to an embodiment of the present application, a ratio (d:r) of the particle size (d) of the colloidal metal oxide to the particle size (r) of the core-shell nanoparticle may be 1:1.005 to 1:30.

According to an embodiment of the present application, a water-soluble calcium compound, a dispersant, a water-dispersible colloidal metal oxide, water, and the like may be used in the method for producing a core-shell nanoparticle. Based on 0.01-50 parts by weight of the water-soluble calcium compound, 0.1-10 parts by weight of the dispersant, 0.01-10 parts by weight of the water-dispersible colloidal metal oxide, and 24-99 parts by weight of the water may be used.

When the amount of the dispersant used is less than 0.1 parts by weight, the viscosity of the mixed solution of the first solution and the second solution becomes too high, making production and use difficult. On the contrary, when the amount of the dispersant is greater than 10 parts by weight, cost reduction is low and phase separation may occur between materials used to produce the core-shell nanoparticle. In addition, the strength is reduced due to the occurrence of bubbles, and unnecessary anti-foaming agents are used to solve this problem. Furthermore, a large amount of dispersant may cause a decrease in early strength of concrete.

According to an embodiment of the present application, the method for producing a core-shell nanoparticle may further include, after the step of producing the core-shell nanoparticle, drying the core-shell nanoparticle. As the drying step, one of the conventional drying methods may be used. Methods such as natural drying, hot air drying, and freeze drying may be used, but the present invention is not limited thereto.

The method for producing a core-shell nanoparticle according to the third aspect of the present application is characterized by using the water-dispersible colloidal metal oxide, and preferably the colloidal silica aqueous solution, and has an effect of adjusting the size of the core-shell nanoparticle by adjusting the size of the colloidal silica nanoparticle. The produced core-shell nanoparticle may have different effects of accelerating early strength according to the size and surface composition thereof. In addition, the method for producing a core-shell nanoparticle is simple in process and has only to adjust the size of the colloidal silica nanoparticle in order to obtain the desired size of the core-shell nanoparticle, thereby obtaining an effect that the time and energy required to obtain the desired size of the core-shell nanoparticle are small and productivity is excellent. The core-shell nanoparticle produced according to the method for producing a core-shell nanoparticle has an effect of accelerating early strength development of concrete, and thus can be used as an admixture for early strength development of concrete, that is, an early strength agent.

Hereinafter, examples of the present invention will be described so that those of ordinary skill in the art may easily carry out the present invention. However, the present invention may be implemented in various different forms and is not limited to the examples described herein.

### EXAMPLES

### Production Examples 1 to 5: Production of Core-Shell Nanoparticle

### Production Example 1

100 g (0.4251 mol) of calcium nitrate tetrahydrate ((CaNO₃)₂·4H₂O, reagent grade), 100 g of a polycarboxylate-based dispersant (available from Silk Road CNT) as a polymer dispersant, and 43 g of distilled water were measured into a 500-ml beaker, were stirred for 30 minutes using a magnetic stirrer, and were thus completely dissolved to prepare a first solution.

42 g (0.2125 mol) of colloidal nano-silica aqueous solution (CNS) having an average particle size of 15 nm, 60 g of NaOH (50%) as a nanoparticle surface active agent, and 420 g of distilled water were measured into a 1,000-ml beaker and were stirred for 24 hours using a magnetic stirrer to prepare a second solution.

After 235 g of distilled water was measured and added into a 2 L four-neck flask reactor, a core-shell nanoparticle was produced by stirring the first solution and the second solution for 120 minutes at 500 rpm using a mechanical stirrer while simultaneously adding the first solution and the second solution to the reactor containing the distilled water.

### Production Example 2

A core-shell nanoparticle was produced in the same manner as in Production Example 1, except that a colloidal nano-silica aqueous solution (CNS) having an average particle size of 45 nm was used instead of the colloidal nano-silica aqueous solution (CNS) having an average particle size of 15 nm in Production Example 1

### Production Example 3

A core-shell nanoparticle was produced in the same manner as in Production Example 1, except that a colloidal nano-silica aqueous solution (CNS) having an average particle size of 85 nm was used instead of the colloidal nano-silica aqueous solution (CNS) having an average particle size of 15 nm in Production Example 1

The amounts of (CaNO₃)₂·4H₂O, the polycarboxylate-based dispersant, the distilled water, the colloidal nano-silica aqueous solution, NaOH, and the particle size of the colloidal nano-silica, which were used in Production Examples 1 to 3, are shown in Table 1 below.

TABLE 1

| | First solution | | | Second solution | | | | |
|---|---|---|---|---|---|---|---|---|
| | | Polycarboxylate- | | | Particle | | | Reactor |
| | | based dispersant | Distilled | | size of | NaOH | Distilled | Distilled |
| Classification | (CaNO₃)₂•4H₂O | (50%) | water | CNS | SiO₂ | (50%) | water | water |
| Production | 100 g | 100 g | 43 g | 42 g | 15 nm | 60 g | 420 g | 235 g |
| Example 1 | | | | | | | | |
| Production | 100 g | 100 g | 43 g | 42 g | 45 nm | 60 g | 420 g | 235 g |
| Example 2 | | | | | | | | |
| Production | 100 g | 100 g | 43 g | 42 g | 85 nm | 60 g | 420 g | 235 g |
| Example 3 | | | | | | | | |

### Examples 1 to 3: Concrete Forming Composition (Including Semi-Strength Cement)

### Example 1

A concrete forming composition including the core-shell nanoparticle produced according to Production Example 1 was produced with the composition shown in Table 2 below.

### Example 2

A concrete forming composition including the core-shell nanoparticle produced according to Production Example 2 was produced with the composition shown in Table 2 below.

### Example 3

A concrete forming composition including the core-shell nanoparticle produced according to Production Example 3 was produced with the composition shown in Table 2 below.

TABLE 2

| | Core-shell | | | | | | | | |
|---|---|---|---|---|---|---|---|---|---|
| | nanoparticle | W/B | S/A | Unit weight (kg/m³) | | | | Ad | Sample |
| Classification | used | (%) | (%) | Water | Cement | Sand | Gravel | (%) | (%) |
| Example 1 | Production | 48.5 | 51 | 165 | 340 | 908 | 892 | 0.3 | 1.3 |
| | Example 1 | | | | | | | | |
| Example 2 | Production | | | | | | | | |
| | Example 2 | | | | | | | | |
| Example 3 | Production | | | | | | | | |
| | Example 3 | | | | | | | | |

W/B: Water/Binder
S/A: Percentage of absolute volume of fine aggregate (S) with respect to total aggregate (A) (fine aggregate + coarse aggregate)
Cement: Semi-strength cement (Asia Cement Co., Ltd.)
Sand: Crushed sand
Gravel: Coarse aggregate with diameter of 25 mm
Ad: Polycarboxylate-based dispersant (20%) solution
Sample: Core-shell nanoparticles produced according to Production Examples 1 to 3

### Examples 4 to 6: Concrete Forming Composition (Including OPC Cement)

### Example 4

A concrete forming composition including the core-shell nanoparticle produced according to Production Example 1 was produced with the composition shown in Table 3 below.

### Example 5

A concrete forming composition including the core-shell nanoparticle produced according to Production Example 2 was produced with the composition shown in Table 3 below.

### Example 6

A concrete forming composition including the core-shell nanoparticle produced according to Production Example 3 was produced with the composition shown in Table 3 below.

TABLE 3

| | Core-shell | | | | | | | | |
|---|---|---|---|---|---|---|---|---|---|
| | nanoparticle | W/B | S/A | Unit weight (kg/m³) | | | | Ad | Sample |
| Classification | used | (%) | (%) | Water | Cement | Sand | Gravel | (%) | (%) |
| Example 4 | Production | 48.5 | 51 | 165 | 340 | 908 | 892 | 0.3 | 1.3 |
| | Example 1 | | | | | | | | |
| Example 5 | Production | | | | | | | | |
| | Example 2 | | | | | | | | |
| Example 6 | Production | | | | | | | | |
| | Example 3 | | | | | | | | |

W/B: Water/Binder
S/A: Percentage of absolute volume of fine aggregate (S) with respect to total aggregate (A) (fine aggregate + coarse aggregate)
Cement: OPC (Ssangyong)
Sand: Crushed sand
Gravel: Coarse aggregate with diameter of 25 mm
Ad: Polycarboxylate-based dispersant (20%) solution
Sample: Core-shell nanoparticles produced according to Production Examples 1 to 3

### Experimental Examples

### Experimental Example 1: Particle Size Evaluation

The particle sizes of the core-shell nanoparticles produced according to Production Examples 1 to 3 were measured using a particle size analyzer (Malvern Instruments LTD. Zetasizer Nano ZSP). The results thereof are shown in Table 4 below.

TABLE 4

| Classification | Average particle size (nm) |
|---|---|
| Production Example 1 | 51 |
| Production Example 2 | 106 |
| Production Example 3 | 152 |

Referring to Table 4, in the case of Production Examples 1 to 3, it was confirmed that the size of the produced core-shell nanoparticle was adjusted according to the size of the colloidal silica nanoparticle. That is, it was confirmed that as the size of the colloidal silica nanoparticle increased, the size of the produced core-shell nanoparticle increased.

### Experimental Example 2: Concrete Performance Evaluation

In order to evaluate the concrete early strength performance of the concrete forming compositions produced according to Examples 1 to 6, the compressive strength for each curing temperature and curing time was measured. The compressive strength was compared by producing a concrete forming composition of Control Example with the composition shown in Table 5 below.

TABLE 5

| | | | | | | | | Sam- |
|---|---|---|---|---|---|---|---|---|
| Classifi- | W/B | S/A | Unit weight (kg/m³) | | | | Ad | ple |
| cation | (%) | (%) | Water | Cement | Sand | Gravel | (%) | (%) |
| Control | 48.5 | 51 | 165 | 340 | 908 | 892 | 1.1 | — |

The curing temperatures of Examples 1 to 3 using semi-strength cement (Asia Cement Co., Ltd.) were 13° C., and the compressive strength for each elapsed time (hr) is shown in Table 6 below.

TABLE 6

| | Compressive strength for each elapsed time (hr) (MPa) | | | | | |
|---|---|---|---|---|---|---|
| Classification | 13 | 14 | 15 | 16 | 17 | 18 |
| Control | 0.83 | 1.54 | 2.11 | 3.28 | 4.34 | 5.15 |
| Example 1 | 5.19 | 6.31 | 7.60 | 9.16 | 10.21 | 11.02 |
| Example 2 | 5.35 | 6.25 | 7.53 | 9.04 | 10.15 | 11.11 |
| Example 3 | 5.11 | 6.15 | 7.39 | 9.28 | 10.29 | 11.23 |

The curing temperatures of Examples 4 to 6 using OPC (Ssangyong) were 15° C., and the compressive strength for each elapsed time (hr) is shown in Table 7 below.

TABLE 7

| | Compressive strength for each elapsed time (hr) (MPa) | | | | | |
|---|---|---|---|---|---|---|
| Classification | 21 | 22 | 23 | 24 | 25 | 26 |
| Control | 0.61 | 1.25 | 1.74 | 2.36 | 2.73 | 3.12 |
| Example 4 | 3.44 | 4.05 | 4.46 | 5.25 | 6.01 | 6.84 |
| Example 5 | 3.25 | 3.92 | 4.33 | 5.11 | 6.15 | 6.71 |
| Example 6 | 3.56 | 4.11 | 4.29 | 5.36 | 6.22 | 6.96 |

Referring to Tables 6 and 7 above, it was confirmed that the concrete produced by adding the core-shell nanoparticle for early strength development of concrete according to the present invention had more excellent compressive strength than the concrete (Control) to which the core-shell nanoparticle was not added. This is considered to be the result obtained when the core-shell nanoparticle accelerates early strength development of concrete. Therefore, it was confirmed that the core-shell nanoparticle for early strength development of concrete according to the present invention could be used as an admixture for early strength development of concrete. Furthermore, early strength can be realized by using the core-shell nanoparticle as the admixture, and the effect of shortening the construction period and reducing the construction cost can be provided.

The present invention has been described in detail with reference to the preferred embodiments and the drawings, but the scope of the technical idea of the present invention is not limited to these drawings and embodiments. Accordingly, various modifications or equivalents thereof may fall within the scope of the technical idea of the present invention. Therefore, the scope of the technical idea according to the present invention should be interpreted by the claims, and the technical idea within the equivalents should be interpreted as falling within the scope of the present invention.

### INDUSTRIAL APPLICABILITY

A core-shell nanoparticle according to the present invention can accelerate early strength development of hydraulic materials, especially concrete, and thus can be used as an early strength development accelerator, and has an effect of shortening the construction period and reducing the construction costs. Therefore, the core-shell nanoparticle according to the present invention is industrially applicable.

1. A core-shell nanoparticle comprising:
a core including a metal oxide; and
a shell positioned on the surface of the core and including an inorganic compound including calcium,
wherein the metal oxide includes at least one metal selected from the group consisting of metalloids, transition metals, post-transition metals, and lanthanum metals.

2. The core-shell nanoparticle of claim 1, wherein the metal oxide includes at least one selected from the group consisting of silica (SiO₂), titanium dioxide (TiO₂), cerium oxide (CeO₂), zinc oxide (ZnO), aluminum oxide (Al₂O₃), zirconium oxide (ZrO₂), manganese oxide (MnO₂), iron oxide (Fe₂O₃), vanadium oxide (V₂O₅), tin oxide (SnO₂), and tungsten oxide (WO₃).

3. The core-shell nanoparticle of claim 1, wherein the inorganic compound including calcium includes at least one selected from the group consisting of calcium silicate, calcium titanate, calcium cerate, calcium zincate, calcium aluminate, calcium zirconate, calcium permanganate, calcium ferrite, calcium vanadate, calcium stannate, calcium tungstate, and any hydrate thereof.

4. The core-shell nanoparticle of claim 1, wherein the shell further includes a polycarboxylate ether-based compound.

5. A concrete forming composition comprising:
aggregate;
a binder;
an admixture; and
water,
wherein the admixture comprises the core-shell nanoparticle for early strength development of concrete according to claim 1.

6. A method for producing a core-shell nanoparticle for early strength development, the method comprising:
producing a core-shell nanoparticle by stirring a first solution containing a water-soluble calcium compound and a second solution containing a water-dispersible colloidal metal oxide,
wherein the core-shell nanoparticle includes a core including a metal oxide, and a shell positioned on the surface of the core and including an inorganic compound including calcium, and
the metal oxide includes at least one metal selected from the group consisting of metalloids, transition metals, post-transition metals, and lanthanum metals.

7. The method of claim 6, wherein a ratio (d:r) of a particle size (d) of the colloidal metal oxide to a particle size (r) of the core-shell nanoparticle is 1:1.005 to 1:30.

8. The method of claim 6, wherein the water-soluble calcium compound includes at least one selected from the group consisting of calcium nitrate, calcium chloride, calcium formate, calcium acetate, calcium bicarbonate, calcium bromide, calcium carbonate, calcium citrate, calcium chlolate, calcium fluoride, calcium gluconate, calcium hydroxide, calcium oxide, calcium hypochlorite, calcium iodide, calcium lactate, calcium nitrite, calcium oxalate, calcium phosphate, calcium propionate, calcium silicate, calcium stearate, calcium sulfate, calcium sulfate hemihydrate, calcium sulfate dihydrate, calcium sulfide, calcium tartrate, calcium aluminate, tricalcium silicate, dicalcium silicate, and any hydrate thereof.

9. The method of claim 6, wherein the first solution and the second solution each independently further include at least one selected from the group consisting of a dispersant, an alkali metal hydroxide, and any combination thereof.

10. The method of claim 9, wherein the dispersant includes a polycarboxylate ether-based compound.

11. The method of claim 9, wherein the alkali metal hydroxide includes at least one selected from the group consisting of sodium hydroxide (NaOH), potassium hydroxide (KOH), and lithium hydroxide (LiOH).

12. The method of claim 9, wherein the first solution further includes a dispersant, and the first solution includes 50-150 parts by weight of the dispersant based on 100 parts by weight of the water-soluble calcium compound.

13. The method of claim 9, wherein the second solution further includes an alkali metal hydroxide, and the second solution includes 100-200 parts by weight of the alkali metal hydroxide based on 100 parts by weight of the water-dispersible colloidal metal oxide.

14. The method of claim 6, further comprising, after the step of producing the core-shell nanoparticle, drying the core-shell nanoparticle.
